(19) United States
(12) Patent Application Publication
(10) Pub. No.: US 2010/0035032 A1
(43) Pub. Date: Feb. 11, 2010

(54) DECORATIVE FOIL

(75) Inventors: Johann Aigner, Klam (AT); Johann Hilburger, Pirk (DE); Martin Bergsmann, Linz (AT); Markus Berger, Nürnberg (DE)

Correspondence Address: WENDEROTH, LIND & PONACK, L.L.P., 1030 15th Street, N.W.,, Suite 400 East, Washington, DC, 20005-1503, US

(73) Assignee: HUECK FOLIEN GES.M.B.H, Baumgartenberg (AT)

(21) Appl. No.: 12/084,687

(22) PCT Filed: Nov. 10, 2006
(86) PCT No.: PCT/EP2006/010810

§ 371 Date: Sep. 24, 2009

(30) Foreign Application Priority Data
Nov. 12, 2005 (EP) 05024766.7

(51) Int. Cl. B32B 3/10

(52) U.S. Cl. 428/209

(57) ABSTRACT

A decorative foil which can be applied to any support, wherein the foil is composed of a polymeric carrier foil that is provided with a metallic layer and/or print and at least one, protective lacquer layer.

The invention relates to a decorative foil for the universal lamination on any desired carrier.

Application of decorative layers onto carriers is conventionally carried out using a transfer film, the decorative layers being transferred onto the carrier and the carrier film optionally being removed after the transfer onto the carrier.

US 2003/0190485 discloses a deep-drawable composite sheet for decorative purposes, comprised of a translucent or transparent foil layer, an adhesive layer, a further transparent or translucent foil including a metal layer, and a further adhesive layer and a carrier foil. The metallic layer is thus laminated between carrier foils.

The disadvantage of this composite sheet is its lack of resistance against external effects. Due to the shearing forces occurring during the application, the lamination can become detached and corrosion of the metallic layer occurs thereby.

The invention addresses the problem of providing a universally utilizable decorative foil which has excellent chemical and mechanical resistance and which can be laminated on any desired carrier.

Subject matter of the invention is therefore a decorative foil for application on any desired carrier, characterized in that the foil is comprised of a polymer carrier film provided with a metallic layer and/or an imprint and at least one protective lacquer layer.

Suitable polymer carrier films are for example flexible synthetic films of, for example, PI, PP, MOPP, PE, PPS, PEEK, PEK, PEI, PSU, PAEK, LCP, PEN, PBT, PET, PA, PMMA, PC, COC, POM, ABS or PVC. The carrier films preferably have a thickness of 5-700 μm, preferably 5-200 μm, particularly preferably 5-50 μm.

Especially preferred are deep-drawable polyester films, such as PET-G, A-PET or O-PET.

The carrier film can be structured, for example it can be embossed or brushed, transparent or translucent, colored, matt or opaque.

Onto the carrier film is applied a metallic coating or an imprint.

Depending on the requirement, this coating can be applied over the entire surface or only partially.

Suitable metallic coatings are, for example, Al, Cu, Ag, Au, Ni, Cr, Pt, Pd and the like. As metallic coating can further also be applied alloys, metal mixtures or metal compounds, such as oxides, chromates or sulfides. Suitable are, for example, Cu-Al or Al-Cr alloys, or metal compounds, in particular TiO₂, Cr oxides, ZnS, ITO, bi-oxide, ATO, FTO, ZnO or Al₂O₃, Zn chromate, Fe oxides, CuO and the like.

The metallic coating can be applied using printing methods, such as gravure printing, screen printing, flexographic printing, digital printing, curtain coating and the like, metallization and, if applicable, demetallization, sputtering, vapor deposition by means of a PVD or CVD method, electroplating, roller application techniques and the like. The metallic coating can further be applied by lamination using a metal foil, for example through hot-melt lamination or IR-supported using homologous adhesives.

In a PVD method the coating is deposited onto the carrier substrate under vacuum (up to 10⁻¹² mbar, preferably 10⁻² to 10⁻⁶ mbar) at temperatures depending on the vapor pressure and the thickness of the coating to be applied, for example by thermal vaporization, arc vaporization or electron beam vaporization. A further feasibility for applying the coating is using AC or DC sputtering, wherein the appropriate method is chosen depending on the thickness of the layer to be applied and the material utilized.

In a CVD method, by mixing the substance to be applied with a gas, plasma or with an activation gas, for example CO, CO₂, oxygen, silanes, methane, ammonia and the like, a chemical reaction is initiated by means of an ion beam, and the resulting substance is deposited on the carrier. In this manner, several reactive layers can be applied simultaneously or parallel and a color effect is generated on the carrier substrate.

If indicated, the layer comprising the optically active feature is treated beforehand by means of an inline plasma, corona or flame process and the coating according to the invention is subsequently applied either inline or in a succeeding method step in a PVD or CVD method, sputtering or the like.

The surface is cleaned of possibly present toning residues using high-energy plasma, for example Ar or Ar/O₂ plasma. The adhesion of the partial or complete coating is thereby further improved.

For the lamination with a metal foil, a dispersion or a solution of a homologous lamination adhesive means is applied onto the provided synthetic film, and the dispersant or solvent is subsequently completely vaporized in a drying tunnel, whereupon the film is bonded with the metal foil under pressure in a laminating unit at the melting temperature of the dry laminating means.

The thickness of the metallic coating is conventionally 5 nm to 30 μm, preferably 20 nm to 3 μm.

The carrier substrate can optionally further comprise an additional pressure layer with optical properties, for example a layer including color pigments, pearlescent pigments and the like.

At least one protective lacquer layer is applied onto the metallic coating.

The protective lacquer coat or the protective lacquer coatings ensure high chemical and mechanical resistance of the foil material.

The protective lacquer can be a chemically, thermally or radiation curing protective lacquer system, for example such as is UV curing or electron beam-curing, based on a polyester, an epoxy or polyurethane system or a system based on their copolymers.

Especially suitable is a protective lacquer comprised of a system of at least two components based on polyurethane with basic components such as polyester, PVC, PVOH, polyvinyl butyral, polyacrylate and/or epoxide, cross-linked with aromatic or aliphatic isocyanates.

The protective lacquer can be pigmented or unpigmented, wherein the pigment fraction can be up to 30%, preferably up to 15%, wherein all known and conventional pigments are suitable, for example inorganic and/or organic pigments such as for example titanium dioxide, zinc sulfide, kaolin, barium sulfate, aluminum, chromium and silicon oxides, metal pigments (for example copper, aluminum, silver, gold, iron, chromium and the like), metal alloys, such as copper-zinc or copper-aluminum as well as also colored, if applicable, organic pigments, such as phthalocyanine blue, i-indolidine yellow, dioxazine purple, or also amorphous or crystalline ceramic pigments such as ITO, ATO, FTO and the like or also liquid crystal pigments.

Furthermore are also utilizable colored and/or encapsulated pigments in chemically, physically or reactively drying binding agent systems.

As coloring substances can be considered, for example, 1,1- or 1,2-chromium cobalt complexes.

For example, inorganic corrosion protection additives, such as Zn phosphate or organic corrosion protection additives, such as toluol triazo derivatives can be added for the protection of metallic layers.

To attain increased protection against radiation of various wavelengths, UV absorbers, radical scavengers (HALS), for example sterically hindered amines and the like, can for example be added.

Furthermore can be added known oxidation inhibitors, for example phenolic antioxidants, fire-proofing additives, for example known halogenated or halogen-free fire-proofing additives, high-temperature stabilizers based on disulfides or thioethers.

To increase the mechanical resistance, for example the abrasion resistance, the shearing and expansion protection, the rolling strength and the like are preferably added elastomeric modifiers, for example elastomeric polymers and copolymers, such as EPR or nanoparticles and the like.

The thickness or the protective lacquer layer(s) is approximately 1 to 10 μm, preferably 2 to 5 μm.

The foil assembly according to the invention can be applied onto the carrier by means of an adhesive agent.

As adhesive systems can be considered known hot-melt adhesive coatings, hot-melt adhesive films, PVC or polyester adhesive systems.

As carriers are herein suitable metallic surfaces, such as steel, synthetic materials, wood, paper, cardboard, woven fabrics, non-woven fabrics of natural or synthetic fibers, glass, ceramic and the like.

The foil assembly according to the invention is capable of being deep drawn or back-injection molded and has high chemical and mechanical resistance and can therefore be utilized inter alia in automotive engineering, in the field of architecture, furniture construction and for electric devices, refrigerators, (white goods (household appliances)), toasters, portable electric devices (handle goods (portable devices)), ghetto blasters, wall panels, interior and exterior decoration or audio and video computer housings.

1. Decorative foil for application on any desired carrier, wherein the foil is comprised of a polymer carrier film provided with a metallic layer and/or an imprint and at least one protective lacquer layer.

2. Decorative foil as claimed in claim 1, wherein the polymer carrier film is a polyester film capable of being deep drawn.

3. Decorative foil as claimed in claim 1, wherein the metallic layer is a layer comprised of Al, Cu, Ag, Au, N, Cr, Pt, Pd, of a Cu-Al or Al-Cr alloy or of an oxide, sulfide or chromate of a metal.

4. Decorative foil as claimed in claim 1, wherein the thickness of the metallic coating is 5 nm to 30 μm.

5. Decorative foil as claimed in claim 1, wherein the protective lacquer layer is comprised of a protective lacquer system based on a polyester, an epoxide or polyurethane system.

6. Decorative foil as claimed in claim 1. wherein the thickness of the protective lacquer layer is 1 to 10 μm.

7. Decorative foil as claimed in claim 1, wherein the protective lacquer layer comprises additives for increasing the mechanical and chemical resistance and for increasing the resistance against visible and UV radiation.

8. Decorative foil as claimed in claim l, wherein the foil comprises a further layer having optical properties.

9. (canceled)

10. Automotive, electrical, architectural and furniture products comprising the decorative foil of claim 1
